(19) United States
(12) Patent Application Publication
(10) Pub. No.: US 2023/0379997 A1
(43) Pub. Date: Nov. 23, 2023

(54) Vehicle and Method of Controlling the Same

(71) Applicants: Hyundai Motor Company, Seoul (KR); Kia Corporation, Seoul (KR)

(72) Inventor: Jaeyoon Ko, Yongin-si (KR)

(21) Appl. No.: 18/063,806

(22) Filed: Dec. 9, 2022

(30) Foreign Application Priority Data
May 17, 2022 (KR) 10-2022-0060027

(51) Int. Cl. H04W 76/19; H04W 52/02; H04W 4/40

(52) U.S. Cl. CPC H04W 76/19; H04W 52/0261; H04W 4/40

(57) ABSTRACT

An embodiment method of controlling a vehicle includes trying a communication network connection to a service provider from a connected car terminal provided in the vehicle. In response to a failure of the communication network connection, the communication network connection is retried based on a predetermined retry condition according to a state of the vehicle.

### CROSS-REFERENCE TO RELATED APPLICATIONS

This application claims the benefit of Korean Patent Application No. 10-2022-0060027, filed on May 17, 2022, which application is hereby incorporated herein by reference.

### TECHNICAL FIELD

Embodiments of the present disclosure relate to a vehicle and to a method of controlling the same.

### BACKGROUND

A connected car service communicates with other vehicles, transportation infrastructure, communication infrastructure, and mobile devices in real time, provides a driver's convenience and traffic safety, and provides various Internet services. In addition, the connected car service enables communication with other vehicles to transmit or receive collision warning signals, intersection control information, or the like. In addition, the connected car service provides traffic safety support, real-time route guidance, vehicle inspection services, and the like from a traffic center. A passenger may also use music and movie streaming services, real-time weather and news search services, and the like using Wi-Fi communication of a vehicle or a mobile device as a hotspot. The connected car service also provides services, such as e-mail, route guidance, life information, theft detection, and voice memos.

In order to use the connected car service in the vehicle, a connected car terminal needs to be connected to a communication network of a service provider through a communication modem. However, when the communication modem is not connected to the communication network due to non-registration or communication errors, it may cause inconvenience to the user (driver) because the communication modem needs to be physically reset.

### SUMMARY

Embodiments of the present disclosure relate to a vehicle and to a method of controlling the same. Particular embodiments relate to a vehicle and to a communication connection with the vehicle.

Therefore, an embodiment of the present disclosure automatically retries a communication network connection without user intervention according to a predetermined retry condition when a connected car terminal of a vehicle is not connected to a communication network of a service provider.

Additional embodiments of the disclosure will be set forth in part in the description which follows and, in part, will be obvious from the description, or may be learned by practice of the disclosure.

In accordance with one embodiment of the present disclosure, a method of controlling a vehicle includes trying a communication network connection to a service provider from a connected car terminal provided in a vehicle and retrying the communication network connection based on a predetermined retry condition according to a state of the vehicle when the communication network connection fails.

The retry condition may include a retry interval and the number of retries, and the communication network connection may be retried according to the retry interval and the number of retries.

The state of the vehicle may include a state of charge (SoC) of a battery mounted in the vehicle.

As a charged amount of the battery is increased, the retry interval may be set shorter and the number of retries may be set greater.

The state of the vehicle may further include an ON state and an OFF state of an engine mounted in the vehicle.

The retry interval when the engine is in the OFF state may be set to be longer than the retry interval when the engine is in the ON state, and the number of retries when the engine is in the OFF state may be set to be smaller than the number of retries when the engine is in the ON state.

The state of the vehicle may further include a power ON state and a power OFF state of the vehicle.

The retry interval when the vehicle is in the power OFF state may be set to be longer than the retry interval when the vehicle is in the power ON state, and the number of retries when the vehicle is in the power OFF state may be set to be smaller than the number of retries when the vehicle is in the power ON state.

The connected car terminal may try the communication network connection to the service provider through a communication modem and may involve a reset of the communication modem whenever retrying the communication network connection.

The method may further include updating a current retry condition according to a changed state of the vehicle when the state of the vehicle is changed.

In accordance with another embodiment of the present disclosure, a vehicle includes a connected car terminal provided in a vehicle to use a connected car service and a communication modem provided to connect the connected car terminal to a communication network of a service provider, wherein the connected car terminal tries a communication network connection to the service provider and retries the connection network connection based on a predetermined retry condition according to a state of the vehicle when the communication network connection fails.

The retry condition may include a retry interval and the number of retries, and the communication network connection may be retried according to the retry interval and the number of retries.

The state of the vehicle may include a state of charge (SoC) of a battery mounted in the vehicle.

As a charged amount of the battery is increased, the retry interval may be set shorter and the number of retries may be set greater.

The state of the vehicle may further include an ON state and an OFF state of an engine mounted in the vehicle.

The retry interval when the engine is in the OFF state may be set to be longer than the retry interval when the engine is in the ON state, and the number of retries when the engine is in the OFF state may be set to be smaller than the number of retries when the engine is in the ON state.

The state of the vehicle may further include a power ON state and a power OFF state of the vehicle.

The retry interval when the vehicle is in the power OFF state may be set to be longer than the retry interval when the vehicle is in the power ON state, and the number of retries when the vehicle is in the power OFF state may be set to be smaller than the number of retries when the vehicle is in the power ON state.

The connected car terminal may try the communication network connection to the service provider through the communication modem and involve a reset of the communication modem whenever retrying the communication network connection.

When the state of the vehicle is changed, the connected car terminal may update a current retry condition according to a changed state of the vehicle.

### BRIEF DESCRIPTION OF THE DRAWINGS

These and/or other embodiments of the disclosure will become apparent and more readily appreciated from the following description of exemplary embodiments, taken in conjunction with the accompanying drawings, in which:

FIG. 1 is a view showing a connected car system of a vehicle according to one embodiment of the present disclosure;

FIG. 2 is a view showing a control flow of the connected car system according to the embodiment of the present disclosure;

FIG. 3 is a view showing a method of setting a communication network connection retry of a vehicle according to an embodiment of the present disclosure;

FIG. 4 is a view showing a method of updating a communication network connection retry set value of a vehicle according to an embodiment of the present disclosure;

FIG. 5 is a view showing an example of a reference table for updating the communication network connection retry set value shown in FIG. 4; and

FIG. 6 is a view showing a method of connecting a communication network of a vehicle according to an embodiment of the present disclosure.

### DETAILED DESCRIPTION OF ILLUSTRATIVE EMBODIMENTS

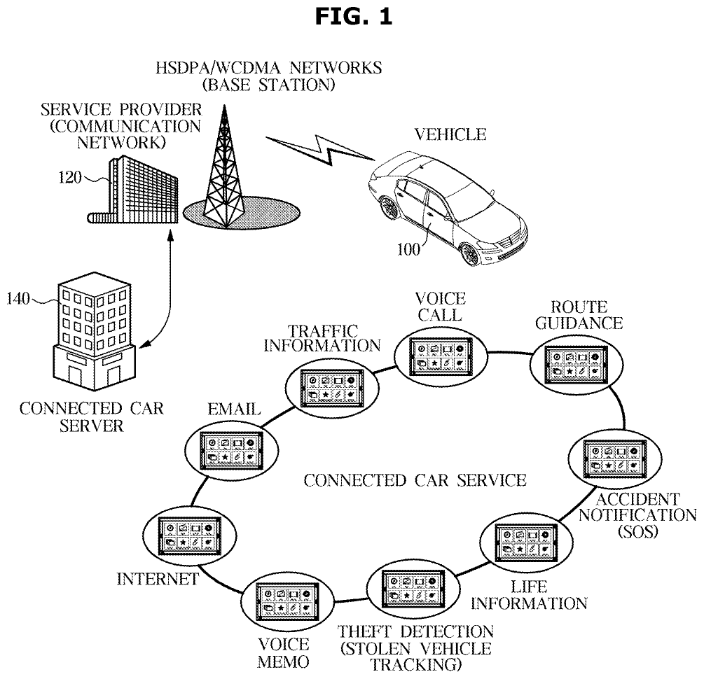

FIG. 1 is a view showing a connected car system of a vehicle according to one embodiment of the present disclosure.

As shown in FIG. 1, a vehicle 100 may use a connected car service provided from a connected car server by communicating with a connected car server 140 through a communication network of a service provider 120.

A connected car service communicates with other vehicles, transportation infrastructure, communication infrastructure, and mobile devices in real time, provides a driver's convenience and traffic safety, and provides various Internet services. In addition, the connected car service enables communication with other vehicles to transmit or receive collision warning signals, intersection control information, or the like. In addition, the connected car service provides traffic safety support, real-time route guidance, vehicle inspection services, and the like from a traffic center. A passenger may also use music and movie streaming services, real-time weather and news search services, and the like using Wi-Fi communication of the vehicle 100 or a mobile device as a hotspot. The connected car service also provides services, such as e-mail, route guidance, life information, theft detection, and voice memos.

The connected car service includes a paid service and a free service, and upon mid-term cancellation, the residual right may be transferred to another user. In an embodiment of the present disclosure, when a user (owner) of the vehicle 100 is changed due to, for example, a used car sale, transfer, or the like, information on the connected car service may be informed to a new user (owner) according to a current connected car service state of the vehicle 100, and a succession procedure of the right to use the rest may be performed according to the selection of the new user (owner).

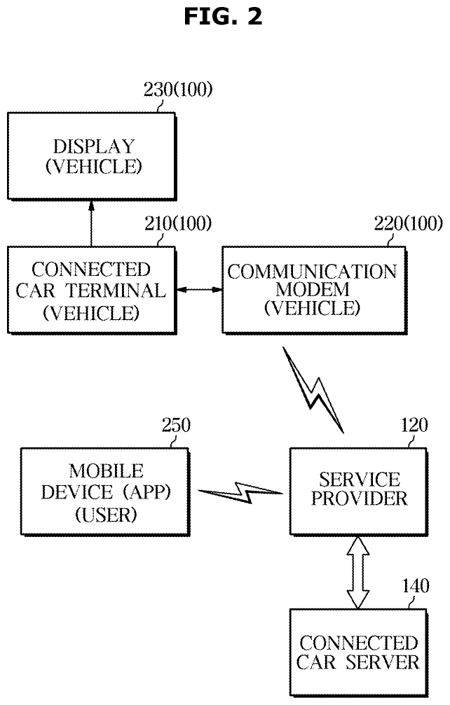

FIG. 2 is a view showing a control flow of the connected car system according to an embodiment of the present disclosure.

In FIG. 2, a connected car terminal 210 and a communication modem 220 are devices mounted on the vehicle 100. A mobile device 250 is a communication device (e.g., a mobile phone) carried by a user (passenger).

The service provider 120 allows the vehicle 100 subscribed to the connected car service to communicate with the connected car server 140 by providing a wireless communication network. The connected car server 140 provides various connected car services to the vehicle 100 subscribed to the connected car service.

An app for subscribing and accessing the connected car service may be installed in the mobile device 250. The user (passenger) may subscribe to the connected car service through the app installed in the mobile device 250. In addition, the user (passenger) who has already subscribed to the connected car service may use the corresponding service by logging in to the connected car service through the app installed in the mobile device 250.

The connected car terminal 210 receives and stores information on the connected car service of the corresponding vehicle 100 from the connected car server 140 and displays the information on the connected car service through a display 230 so that the user (passenger) may confirm the information on the connected car service of the corresponding vehicle 100.

A memory (not shown) for storing the information on the connected car service may be provided in the connected car terminal 210.

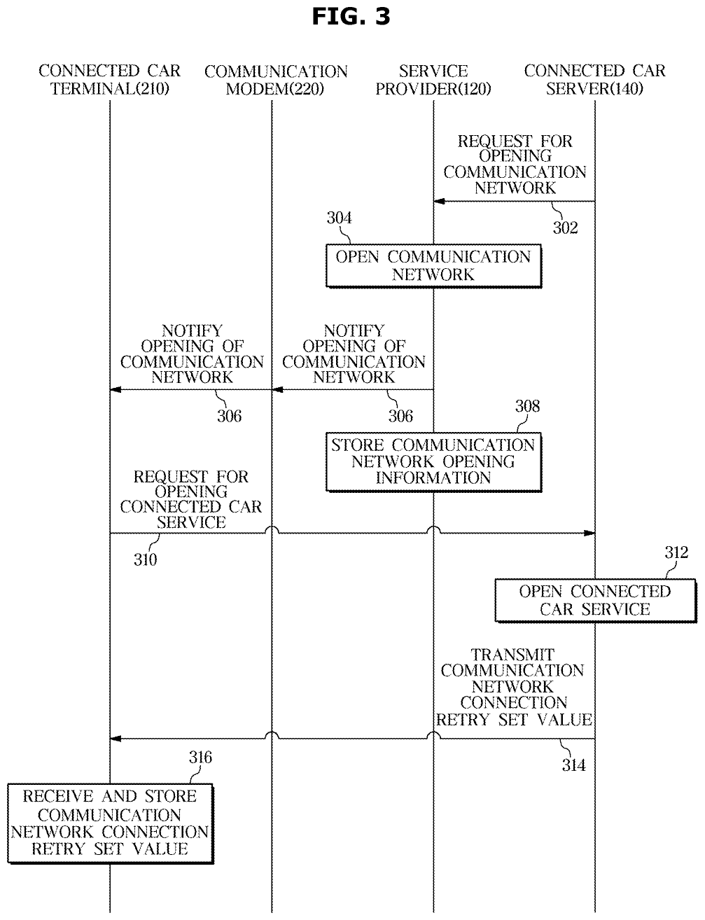

FIG. 3 is a view showing a method of setting a communication network connection retry of a vehicle according to an embodiment of the present disclosure. Through the method of FIG. 3, a set value related to retrying the communication network connection of the vehicle may be determined.

As shown in FIG. 3, the connected car server 140 requests the service provider 120 to open a communication network for communication of the connected car terminal 210 of the vehicle 100 (302). To this end, the connected car server 140 may provide related information on the connected car terminal 210 to the service provider 120. The related information may be information for authenticating the connected car terminal 210.

The service provider 120 opens the communication network for communication of the connected car terminal 210 in response to the communication network opening request from the connected car server 140 (304). In this case, the service provider 120 may confirm whether the corresponding connected car terminal 210 satisfies conditions for opening the communication network and open the communication network for the communication of the connected car terminal 210 when the conditions are satisfied.

The service provider 120 notifies the connected car terminal 210 that the communication network of the connected car terminal 210 has been opened through the communication modem 220 of the vehicle 100 (306). At the same time, the service provider 120 stores the opening information of the connected car terminal 210 in a server (not shown) of the service provider 120 itself (308).

The connected car terminal 210 of which the communication network has been opened may communicate with the connected car server 140 through the opened communication network. The connected car terminal 210 requests the connected car server 140 to open the connected car service through the communication network (310). In order for the connected car terminal 210 to use the connected car service, both the opening of the communication network and the opening of the connected car service are required.

The connected car server 140 opens the connected car service for the connected car terminal 210 in response to the service opening request from the connected car terminal 210 (312).

When the opening of the connected car service is completed, the connected car server 140 transmits a communication network connection retry set value to the connected car terminal 210 (314).

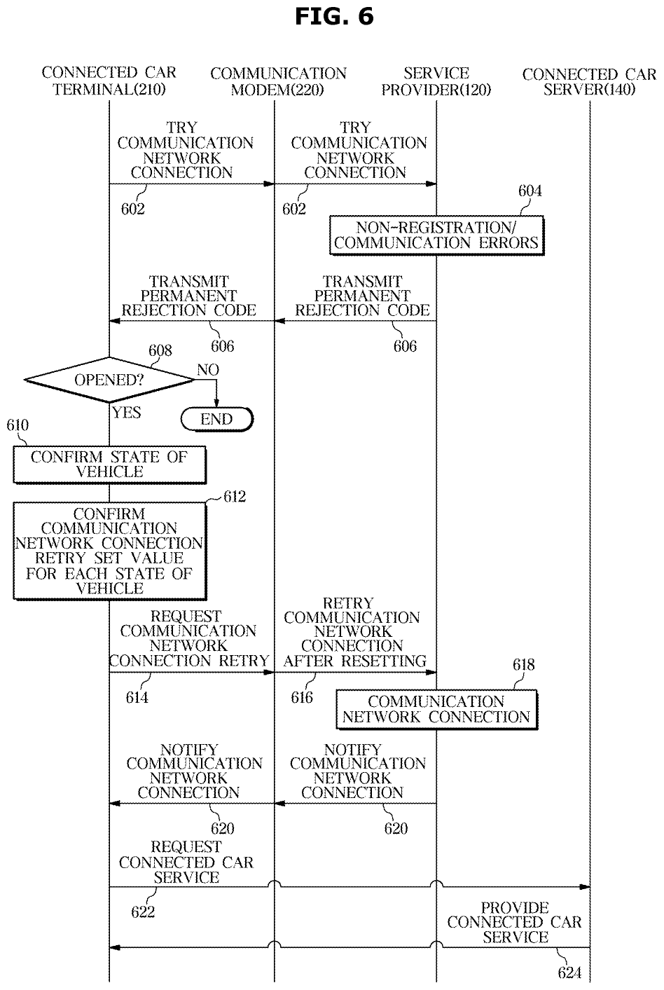

The connected car terminal 210 of the vehicle 100 receives and stores the communication network connection retry set value from the connected car server 140 (316). When trying to connect to the communication network of the service provider 120 through the communication modem 220, the connected car terminal 210 may retry the communication network connection when the communication network connection is rejected by the service provider 120 due to non-registration, communication errors, or the like. At this time, the connected car terminal 210 may retry the communication network connection of the service provider 120 based on the communication network connection retry set value received from the connected car server 140 and stored. The communication network connection retry set value determines the number of retries and a retry interval. The rejection of the communication network connection by the service provider 120 due to non-registration, communication errors, or the like will be described in detail with reference to FIG. 6 to be described below.

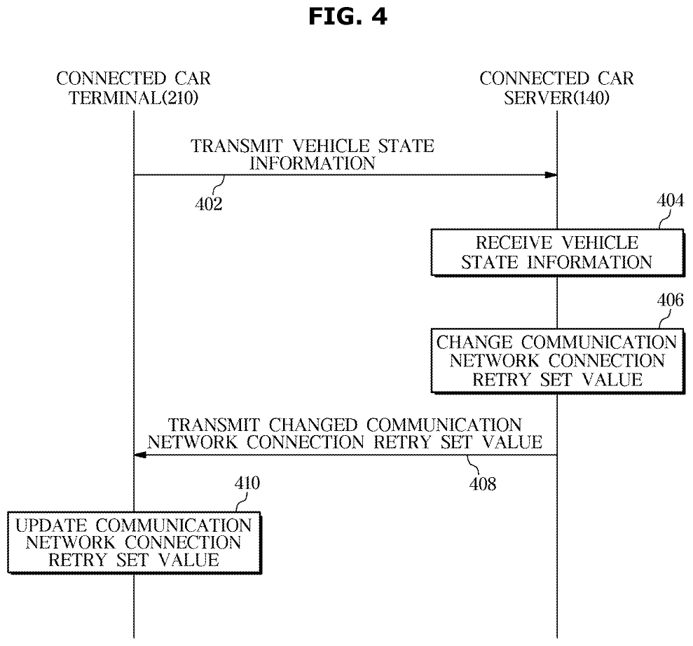

FIG. 4 is a view showing a method of updating a communication network connection retry set value of a vehicle according to an embodiment of the present disclosure. According to the method of FIG. 4, the communication network connection retry set value already set and stored in the connected car terminal 210 may be updated based on a change in a state of the vehicle 100.

As shown in FIG. 4, the connected car terminal 210 transmits state information of the vehicle 100 to the connected car server 140 (402). The state information of the vehicle 100 may include state of charge (SoC) information of a battery, ignition ON/OFF information of an engine, and power ON/OFF information of the vehicle 100. When the vehicle 100 is equipped with an internal combustion engine, the ignition ON/OFF information of the engine may be used as the state information of the vehicle 100. When the vehicle 100 is an electric vehicle equipped with a motor, the power ON/OFF information may be used as the state information of the vehicle 100. In other words, information on an ON state or an OFF state of at least one of the engine mounted in the vehicle 100 and power of the vehicle 100 may be used as the state information of the vehicle 100 together with the SoC information of the battery. The communication network connection retry set value may also be determined (changed) by selectively applying at least one of the SoC information of the battery, ON/OFF states of the engine, and ON/OFF states of the power.

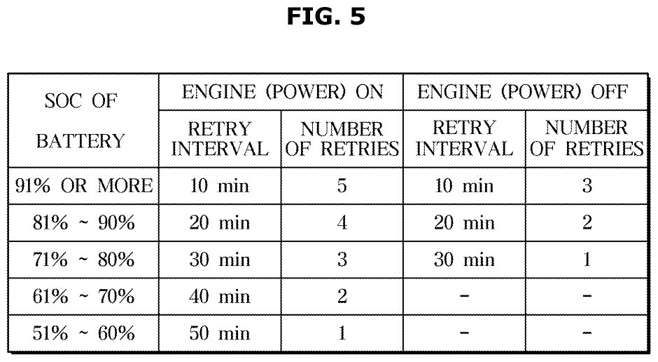

The connected car server 140 receives the vehicle state information from the connected car terminal 210 (404) and changes the communication network connection retry set value based on the received vehicle state information (406). The change in the communication network connection retry set value in the connected car server 140 will be described in detail with reference to FIG. 5.

FIG. 5 is a view showing an example of a reference table for updating the communication network connection retry set value shown in FIG. 4. The table is provided in the connected car server 14o. As shown in FIG. 5, the connected car server 140 may change the communication network connection retry set value to a different value based on the SoC of the battery and the ON/OFF states of the engine (power) of the vehicle 100. When the SoC of the battery is low and the communication network connection retry is performed too frequently in a state in which the engine (power) is also turned off, the SoC of the battery may decrease, thereby negatively affecting the operation of the vehicle 100. Therefore, in an embodiment of the present disclosure, power of the battery is more efficiently used by appropriately changing the communication network connection retry set value as shown in FIG. 5 based on the SoC of the battery and the ON/OFF states of the engine (power) of the vehicle 100.

In FIG. 5, when the SoC of the battery is 91% or more and the engine (power) is in an ON state, a retry interval may be set to 10 minutes and the number of retries may be set to 5 times. When the SoC of the battery is between 81% and 90% and the engine (power) is in an ON state, the retry interval may be set to 20 minutes and the number of retries may be set to 4 times. When the SoC of the battery is between 71% and 80% and the engine (power) is in an ON state, the retry interval may be set to 30 minutes and the number of retries may be set to 3 times. When the SoC of the battery is between 61% and 70% and the engine (power) is in an ON state, the retry interval may be set to 40 minutes and the number of retries may be set to 2 times. When the SoC of the battery is between 51% and 60% and the engine (power) is in an ON state, the retry interval may be set to 50 minutes and the number of retries may be set to 1 time.

When the SoC of the battery is 91% or more and the engine (power) is in an OFF state, the retry interval may be set to 10 minutes and the number of retries may be set to 3 times. When the SoC of the battery is between 81% and 90% and the engine (power) is in an OFF state, the retry interval may be set to 20 minutes and the number of retries may be set to 2 times. When the SoC of the battery is between 71% and 80% and the engine (power) is in an OFF state, the retry interval may be set to 30 minutes and the number of retries may be set to 1 time. When the SoC of the battery is smaller than 60% and the engine (power) is in an OFF state, the retry interval and the number of retries may be set to null values to prevent retrying from being performed.

As described above, the smaller the SoC of the battery, the greater the retry interval (less frequently) and the lower the number of retries. In addition, as shown in FIG. 5, when the SoC of the battery is smaller than or equal to a certain % in the OFF state of the engine (power), it is possible to limit the communication network connection retry from being performed.

In FIG. 5, in a state in which the SoC of the battery is the same, the number of retries is different from each other when the engine (power) is in the ON state and the OFF state. In other words, even in the state in which the SoC of the battery is the same, the number of retries is relatively less when the engine (power) is in the OFF state than when the engine (power) is in the ON state. When the engine (power) is in the OFF state, the vehicle 100 is in a state of not traveling and thus the battery may not be charged. Therefore, when the engine (power) is in the OFF state, the number of retries is relatively decreased so that less power charged in the battery is consumed. When the engine (power) is in the OFF state, both the retry interval and the number of retries may also be decreased. The retry interval and the number of retries of the communication network connection determined according to the SoC of the battery and the ON/OFF of the engine (power) according to an embodiment of the present disclosure are not limited to those shown in FIG. 5 and may be implemented with other various values and in other various combinations.

Returning back to FIG. 4, as described above, the connected car server 140 changes the communication network connection retry set value based on the SoC information of the battery and the ON/OFF state information of the engine (power) of the vehicle 100 received from the connected car service (406). At this time, reference may be made to the table described above with reference to FIG. 5.

When the communication network connection retry set value is changed, the connected car server 140 transmits the changed communication network connection retry set value to the connected car terminal (408).

The connected car terminal 210 updates the existing communication network connection retry set value stored in the connected car terminal 210 itself with a changed new communication network connection retry set value by receiving the changed new communication network connection retry set value from the connected car server 140 (410). Therefore, the connected car terminal 210 can obtain a new communication network connection retry set value in which the SoC of the battery and the ON/OFF states of the engine (power) of the vehicle 100 are reflected.

FIG. 6 is a view showing a method of connecting a communication network of a vehicle according to an embodiment of the present disclosure.

The connected car terminal 210 needs to request the connected car service from the connected car server 140 through the communication network of the service provider 120 in order to use the connected car service. To this end, the connected car terminal 210 tries (requests) a communication network connection with (to) the service provider 120 through the communication modem 220 (602).

The service provider 120 receiving the request for the communication network connection from the connected car terminal 210 of the vehicle 100 may perform the communication network connection of the corresponding connected car terminal 210. However, when the connected car terminal 210 is an unregistered terminal or communication errors occur even using a registered terminal, the communication network connection may not be possible (604).

As described above, when the communication network connection is not available due to non-registration or communication errors, the service provider 120 notifies that the communication network connection is not available by transmitting a permanent rejection code through the communication modem 220 of the vehicle 100 (606). The permanent rejection code is a code defined in the third generation partnership project (3GPP) and is transmitted to a terminal requesting a network connection when a network connection is not available due to non-registration or communication errors. The communication errors may occur because information of the communication modem 220 is not normally transmitted from a previous exchange to a next exchange when an exchange configured to perform communication is changed as a communication area is changed while the vehicle 100 equipped with the connected car terminal 210 moves. For example, when the vehicle 100 moves from a communication area A to a communication area B, the service provider 120 recognizes a communication network connection try of the connected car terminal 210 of the vehicle 100 as an abnormal connection try to generate and transmit the permanent rejection code to the communication modem 220 when the information of the communication modem 220 is not normally transmitted to an exchange of the communication area A to an exchange of the communication area B. In this case, conventionally, the user needs to physically reset the communication modem 220 by disconnecting and reconnecting a communication cable, but in an embodiment of the present disclosure, as described below, it is possible to achieve user convenience upon communication network connection by automatically resetting the communication modem 220 and retrying the communication network connection according to a preset retry interval and the preset number of retries.

When receiving the permanent rejection code from the service provider 120, the connected car terminal 210 checks whether the connected car terminal 210 itself is opened (608). When the connected car terminal 210 itself is in an unopened state (No in operation 608), the communication connection try is terminated.

Conversely, when the connected car terminal 210 itself is in an opened state (Yes in operation 608), the connected car terminal 210 checks the state of the vehicle 100 (610). The state of the vehicle 100 may include the SoC of the battery and the ON/OFF states of the engine (power). In addition, the connected car terminal 210 checks the communication network retry connection set value for each state of the vehicle 100 (S612). The communication network connection retry set value based on the state of the vehicle 100 has been described above with reference to FIGS. 4 and 5.

The connected car terminal 210 requests the communication modem 220 to retry the communication network connection (614), and the communication modem 220 retries the communication network connection involving the reset of the communication modem 220 itself (616). In the connected car terminal 210, the communication network connection retry through the communication modem 220 follows the communication network connection retry set value for each state of the vehicle 100 previously confirmed in operation 612. In other words, the network connection retry is automatically performed according to the retry interval and the number of retries according to the communication network connection retry set value for each state of the vehicle 100 confirmed in operation 612. However, the retry interval and the number of retries according to the communication network connection retry set value for each state of the vehicle 100 are the maximum values and the communication network connection is not retried any more when the communication network connection is successful before the retry interval and the number of retries according to the communication network connection retry set value for each state of the vehicle 100 reach the maximum values.

When the communication network connection fails despite performing the retry by the maximum values of the retry interval and the number of retries according to the communication network connection retry set value for each state of the vehicle 100, a network connection unavailability situation may be displayed on the display 230 of the vehicle 100 and an additional communication network connection retry may be stopped.

Alternatively, when the connected car terminal 210 is successfully connected to the communication network of the service provider 120 because the connected car terminal 210 is in the opened state and no specific communication errors occur either (618), the service provider 120 notifies the connected car terminal 210 through the communication modem 220 that the connected car terminal 210 has been successfully connected to the communication network (620).

The connected car terminal 210 which is notified that the communication network connection has been successful from the service provider 120 may request a predetermined connected car service from the connected car server 140 through the connected communication network (622). The predetermined connected car service may be a service that the user (driver) wants to use among connected car service items available through the connected car terminal 210. The types of the connected car services have been described above with reference to FIG. 1.

The connected car server 140 receiving the request for the connected car service from the connected car terminal 210 provides the connected car service requested by the connected car terminal 210 to the connected car terminal 210 (624). Therefore, the user (driver) of the vehicle 100 may use the connected car service provided through the connected car terminal 210 in the vehicle 100.

As described above, in an embodiment of the present disclosure, even when the user (driver) fails the communication network connection when the user (driver) wants to use the connected car service in the vehicle 100, it is possible to automatically perform the communication network connection without user (driver) intervention by automatically retrying the communication network connection by the retry interval and the number of retries according to the communication network connection retry set value for each state of the vehicle 100.

According to embodiments of the present disclosure, it is possible to provide user convenience by automatically retrying a communication network connection without user intervention according to a predetermined retry condition when a connected car terminal of a vehicle is not connected to a communication network of a service provider.

The above description is merely illustrative of the technical spirit, and various modifications, changes, and substitutions will be possible by those skilled in the art of the present disclosure without departing from the essential characteristics. Therefore, the embodiments disclosed above and the accompanying drawings are for description rather than limiting the technical spirit, and the scope of the technical spirit is not limited by the embodiments and the accompanying drawings. The scope of the present disclosure should be construed by the appended claims, and all technical spirits within the scope equivalent thereto should be construed as being included in the scope of the present disclosure.

What is claimed is:

1. A method of controlling a vehicle, the method comprising:
trying a communication network connection to a service provider from a connected car terminal provided in the vehicle; and
in response to a failure of the communication network connection, retrying the communication network connection based on a predetermined retry condition according to a state of the vehicle.

2. The method of claim 1, wherein:
the retry condition comprises a retry interval and a maximum number of retries; and
the communication network connection is retried according to the retry interval and the maximum number of retries.

3. The method of claim 2, wherein the state of the vehicle comprises a state of charge of a battery mounted in the vehicle.

4. The method of claim 3, wherein as a charged amount of the battery is increased, the retry interval is set shorter and the maximum number of retries is set greater.

5. The method of claim 3, wherein the state of the vehicle further comprises an ON state and an OFF state of an engine mounted in the vehicle.

6. The method of claim 5, wherein:
the retry interval when the engine is in the OFF state is set to be longer than the retry interval when the engine is in the ON state; and
the maximum number of retries when the engine is in the OFF state is set to be smaller than the maximum number of retries when the engine is in the ON state.

7. The method of claim 3, wherein the state of the vehicle further comprises a power ON state and a power OFF state of the vehicle.

8. The method of claim 7, wherein:
the retry interval when the vehicle is in the power OFF state is set to be longer than the retry interval when the vehicle is in the power ON state; and
the maximum number of retries when the vehicle is in the power OFF state is set to be smaller than the maximum number of retries when the vehicle is in the power ON state.

9. The method of claim 3, wherein the connected car terminal tries the communication network connection to the service provider through a communication modem and involves a reset of the communication modem whenever retrying the communication network connection.

10. The method of claim 1, further comprising updating a current retry condition according to a changed state of the vehicle when the state of the vehicle is changed.

11. A vehicle comprising:
a connected car terminal provided in the vehicle and configured to use a connected car service; and
a communication modem provided to connect the connected car terminal to a communication network of a service provider;
wherein the connected car terminal is configured to try a communication network connection to the service provider; and
wherein, in response to a failure of the communication network connection, the connected car terminal is configured to retry the connection network connection based on a predetermined retry condition according to a state of the vehicle.

12. The vehicle of claim 11, wherein:
the retry condition comprises a retry interval and a maximum number of retries; and
the connected car terminal is configured to retry the communication network connection according to the retry interval and the maximum number of retries.

13. The vehicle of claim 12, wherein the state of the vehicle comprises a state of charge of a battery mounted in the vehicle.

14. The vehicle of claim 13, wherein as a charged amount of the battery is increased, the retry interval is set shorter and the maximum number of retries is set greater.

15. The vehicle of claim 13, wherein the state of the vehicle further comprises an ON state and an OFF state of an engine mounted in the vehicle.

16. The vehicle of claim 15, wherein:
the retry interval when the engine is in the OFF state is set to be longer than the retry interval when the engine is in the ON state; and
the maximum number of retries when the engine is in the OFF state is set to be smaller than the maximum number of retries when the engine is in the ON state.

17. The vehicle of claim 13, wherein the state of the vehicle further comprises a power ON state and a power OFF state of the vehicle.

18. The vehicle of claim 17, wherein:
the retry interval when the vehicle is in the power OFF state is set to be longer than the retry interval when the vehicle is in the power ON state; and
the maximum number of retries when the vehicle is in the power OFF state is set to be smaller than the maximum number of retries when the vehicle is in the power ON state.

19. The vehicle of claim 13, wherein:
the connected car terminal is configured to try the communication network connection to the service provider through the communication modem; and
the communication modem is configured to be reset whenever retrying the communication network connection is performed.

20. The vehicle of claim 11, wherein, when the state of the vehicle is changed, the connected car terminal is configured to update a current retry condition according to a changed state of the vehicle.
